(19) United States
(12) Patent Application Publication
(10) Pub. No.: US 2009/0089751 A1
(43) Pub. Date: Apr. 2, 2009

(54) EXPOSING FEATURES OF SOFTWARE PRODUCTS

(75) Inventors: Jeffrey S. Raikes, Seattle, WA (US); Alexander Gounares, Kirkland, WA (US); Brian Meek, Redmond, WA (US); Patrice Y. Simard, Bellevue, WA (US); Ajitesh Kishore, Kirkland, WA (US); Derek Burney, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/864,639

(22) Filed: Sep. 28, 2007

(51) Int. Cl. G06F 9/44

(52) U.S. Cl. 717/120

(57) ABSTRACT

The claimed subject matter provides a system and/or a method that facilitates exposing a software feature to increase productivity of performing a task. A software component can include a plurality of software features in which the software component can rank and assign a skill level to an entity utilizing at least one software feature. A smart help component can supply the entity with an informative tip based on the skill level rank, wherein the informative tip can assist in utilizing at least one software feature.

### BACKGROUND

Today, a lot of software functionality is packaged into very large software applications and software suites. These monolithic applications are oftentimes equipped with an abundance of functionalities that include tools that are only accessed by a very small percentage of the users. By way of example, a conventional word processing application can contain functionalities such as mail merge and macro capabilities not usually accessed by an average user. In most cases, users are not even aware of the scope of functionalities let alone know how to use them.

Many ordinary computer users barely scratch the surface in their use of the software and operating system platform to assist in their private and professional lives. Development of these monolithic applications is a major barrier to the development cycle as well as to selling software. For instance, today, it is not uncommon for a release of a monolithic application to take years to complete before reaching the public.

Although the technologically savvy user is doing great with today's monolithic software approach, a majority of users are not using most of the software they have available in these large applications. Because users do not regularly use some of the features and functionalities available in today's applications, it is not uncommon that they oftentimes forget about the availability of such features and resort to alternative sources and/or applications to accomplish a task. Conventional solutions such as a instruction manuals, help documents, forums, application assistants, pop up tips, frequently asked questions (FAQ), toolbars, and the like are inefficient and time-consuming often resorting in a user having to peruse a wealth of information to satisfy their query to learn more software capabilities. Moreover, educating novice users of software functionalities and building skill levels associated therewith is an important concept with technological advancements since consumer comprehension typically correlates to the development software products (e.g., to satisfy such consumer demand).

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate distributing a tip related to a software feature having a degree of difficulty that correlates to a skill level of a user. A smart help component can supply instructional data or an informative tip based on a skill level rank of such information in order to expose various features of complicated software. In addition, the smart help component can selectively distribute a tip, tactic, suggestion, recommendation, etc. related to a software component or a software feature, wherein an entity has access to such data limited by established expertise, skill level, competence, etc. In one aspect, the smart help component can evaluate skill level of an entity. In another aspect, the software component or the software feature can evaluate the skill level of an entity.

In still another aspect of the subject innovation, the smart help component can receive and verify informative tips and/or instructional data associated with the software component and/of the software feature. The contributed advice (e.g., the informative tip, instructional data, etc.) can be authenticated and further evaluated to identify a respective skill level for entity distribution. Moreover, the smart help component can employ a reward component that can provide incentives to donate information to the smart help component. In yet another aspect of the claimed subject matter, the smart help component can utilize a test component to ascertain, promote, demote, etc. skill level for an entity. In other aspects of the claimed subject matter, methods are provided that facilitate collecting and exposing instructional data for software to a plurality of clients.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates distributing a tip related to a software feature having a degree of difficulty that correlates to a skill level of a user.

FIG. 2 illustrates a block diagram of an exemplary system that facilitates collecting and exposing instructional data for software to a plurality of clients.

FIG. 3 illustrates a block diagram of an exemplary system that facilitates accumulating a software suggestion for usability while providing verification of such suggestion.

FIG. 4 illustrates a block diagram of an exemplary system that facilitates improving consumer knowledge and skill level associated with an application utilizing a test.

FIG. 5 illustrates a block diagram of exemplary system that facilitates incorporating language translation and real time editing into a word processing application.

FIG. 6 illustrates a block diagram of an exemplary system that facilitates sharing an experience related to a software capability or feature.

FIG. 7 illustrates an exemplary methodology for distributing a tip related to a software feature or capability based on skill level.

FIG. 8 illustrates an exemplary methodology that facilitates rewarding a source for the submission of a software tip and providing skill level based data access.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “software,” “client,” “entity,” “network,” “profile,” “store,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

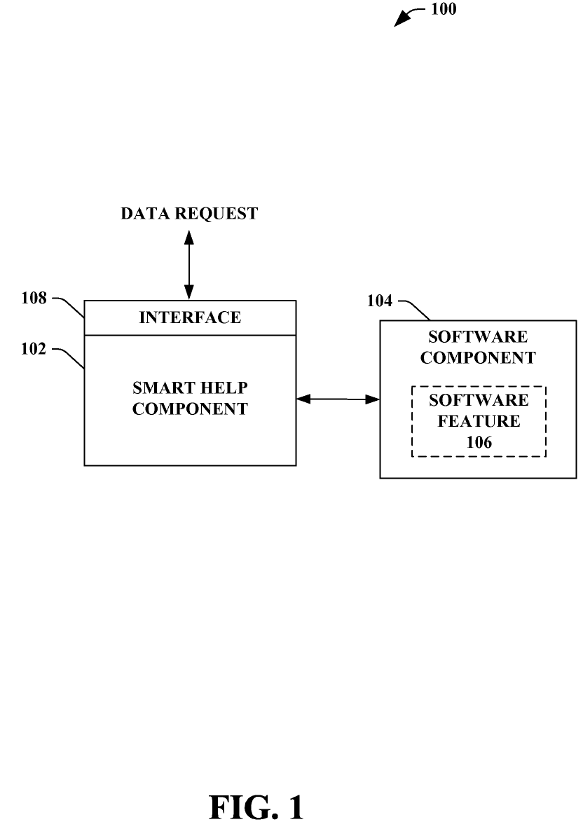

Now turning to the figures, FIG. 1 illustrates a system 100 that facilitates distributing a tip related to a software feature having a degree of difficulty that correlates to a skill level of a user. The system 100 can include a smart help component 102 that can receive a data request via an interface component 108 (herein referred to as “interface 108” and discussed in more detail below), wherein the smart help component 102 can supply an informative tip related to a software component 104 and/or a software feature 106 based on such data request. In general, the smart help component 102 can distribute any suitable instructional data (e.g., tip, tactic, suggestion, trick, shortcut, experience, glitch, etc.) related to the software feature 106 associated with the software component 104 based at least in part upon a skill level of such data request (e.g., data query, search, browsing of data, etc.). In one particular example, the software component 104 can evaluate and rank an entity (e.g., a user, a client, a machine, etc.) to identify a skill level. In another example, the smart help component 102 can evaluate the skill level. Such skill level can be utilized by the smart help component 102 to distribute and/or supply informative data related to the software component 104 and/or the software feature 106. Thus, the system 100 enables the calculated distribution and/or communication of tips, tactics, suggestions, and/or tricks related to the software component 104 by basing access on entity skill level.

For example, a client can understand the general core aspects of a software product (e.g., a portion of software, the software component 104, an application, a portion of an application, etc.) that perform a main task or purpose. For instance, the client can comprehend a word processing application in that one can create a document with text. However, such client may not be able to utilize various sub-features or add-ons within the word processing application such as formatting, tracking changes, email options, inserting objects, etc. Moreover, various users and/or clients can include a variety of skill levels associated with the software and/or the software features in that a low-skilled user may not be able to utilize or understand a high-skilled tip or tactic. Thus, the system 100 can identify instructional data that corresponds to a user or client skill level so as not to over-reach their boundaries or comprehensions.

In a particular example, a first user can be ranked by software as a medium skill level and a second user can be ranked by software as a medium skill level, and a third user can be ranked by software as a low skill level. The third user can generate a data request (e.g., a query, a question, etc.) associated with a software feature or a portion of the software. Based on the low skill level, the access for the third user can be limited to information categorized as “low skill level,” and the medium skill level material would be restricted. This restriction allows the third user to not be overwhelmed or confused (e.g., over-reach their capabilities with the software or the software feature). Moreover, the first and second users can access medium skill level instructional data as well as low skill level instructional data since both are of medium skill level in regards to the software or the software feature. Yet, a high skill level instructional data may be restricted from any user without such skill level (e.g., here the first, second, and third users). It is to be appreciated that there can be any suitable number of skill levels or granular levels associated with ranking an entity experience or knowledge with a software feature or software and the above example is not to be limiting on the subject innovation.

Furthermore, the smart help component 102 can receive data requests via the interface 108 associated with collecting a portion of instructional data (discussed in more detail below). It is to be appreciated that the smart help component 102 can gather and/or distribute instructional data related to the software component 104 and/or the software feature 106, wherein such instructional data or informative tip can be a singleton or synthetic. The singleton informative tip or instructional data can be, but is not limited to being, a tip, a suggestion, a trick, a tactic, a tutorial, a shortcut, an experience from a client, a glitch exposure, an error avoidance, a solution to a problem, a best practice, a software or product recommendation, a modification, a customization, a recommended use, etc. The synthetic tip can be generated on the fly, wherein the synthetic tip is at least one of a portion of data aggregated across two or more users, a collection of data representative of a tactic utilized by two or more users, or a portion of data dynamically correlating with a tip utilized by an entity with a similar skill level. For example, a portion of synthetic data can be aggregated across multiple users. For instance, the smart help component can provide information such as, “9 out of 10 people used the ‘ctrl-b’ shortcut for bold.” It is to be appreciated that this can be utilized with more complex tips or tactics and the above example is not to be limiting on the subject innovation. In another example, an instructional video could be synthesized on a suggestion, instructional data, tip, tactic, and the like on, for instance, excel pivot tables by leveraging aggregated data from multiple users with various skill levels.

For instance, the smart help component 102 can generate an informative tip for a specific entity based at least in part upon the entity's behavior and/or interaction with a social network. Thus, the actions, tasks, communications, and the like can be utilized to assist in identifying and/or locating an informative tip or suggestion to be distributed to the entity. It is to be appreciated that the system 100 can be utilized with any suitable social network or community in order to ascertain particular tips, suggestions, etc. based on a behavior of a user and/or actions of a user related to a skill level.

Furthermore, it is to be appreciated that the instructional data or informative tip can be in any suitable format or file type such as, but not limited to, a portion of audio, a portion of video, a portion of text, a portion of a graphic, a portion of handwriting, a slide show, a presentation, and/or any suitable combination thereof.

In another aspect in accordance with the subject innovation, the smart help component 102 can be a reservoir of such informative tip or instructional data that can be leveraged by developers, companies, enterprises, etc. The informative tips or instructional data gathered by the smart help component 102 can be evaluated to ascertain specific types of use related to the software component 104 and/or the software feature 106. For example, a software component related to performing task A can include software features b, c, and d. Yet, evaluating the collected information tips and/or instructional data it can be ascertained that feature c is most popular or successful while feature d is least popular or successful. Thus, the data can be helpful in software development and/or software feature development (e.g., current and/or future).

In addition, the system 100 can include any suitable and/or necessary interface 108, which provides various adapters, connectors, channels, communication paths, etc. to integrate the smart help component 102 into virtually any operating and/or database system(s) and/or with one another. In addition, the interface 108 can provide various adapters, connectors, channels, communication paths, etc., that provide for interaction with the smart help component 102, the software component 104, the software feature 106, data requests, networks, servers, clients, users, and any other device and/or component associated with the system 100.

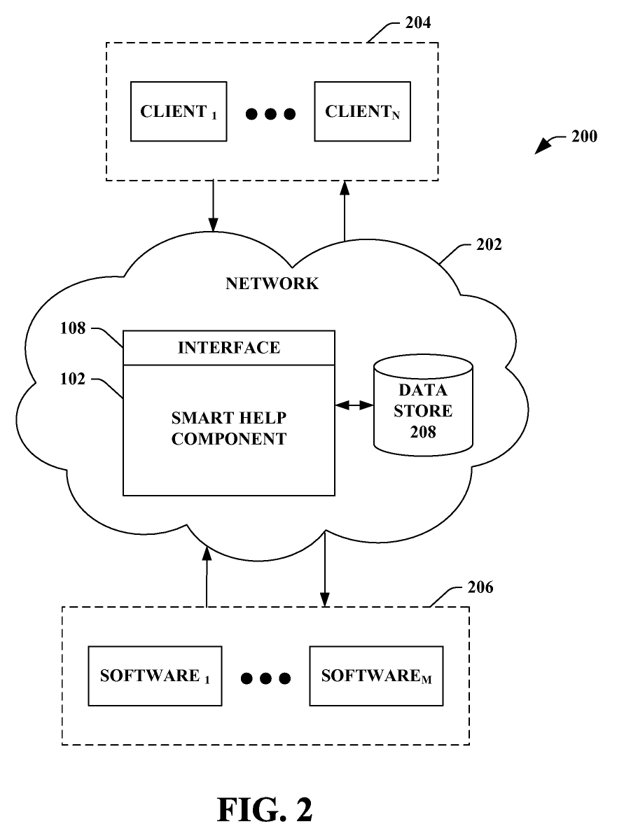

FIG. 2 illustrates a system 200 that facilitates collecting and exposing instructional data for software to a plurality of clients. The system 200 can include the smart help component 102 that can distribute a portion of instructional data or an informative tip for software or an application based at least in part upon a corresponding difficulty or skill level. The smart help component 102 can receive a data request associated with a software component (e.g., also referred to as a portion of software, software, application, a portion of an application, etc.) or a software feature via the interface 108, wherein the data request can be fulfilled based upon skill level rank (ascertained by the software or software feature) to enable skill-appropriate allotment of data.

The smart help component 102 can be associated with a network 202. By implementing the smart help component 102 into the network 202, a plurality of clients 204 can interact with at least one of the network 202 or the smart help component 102. For instance, any suitable number of clients 204 can communicate with the smart help component 102 and/or network 202 such as client ₁ to client _{N}, where N is a positive integer. In one particular example, the clients 204 can receive and/or upload a portion of instructional data or informative tips related to a portion of software (e.g., software component, software feature, portion of application, etc.) in order to establish a social community or network for sharing. Furthermore, the network 202 can be utilized by the clients 204 to interact and/or communicate with software 206 (e.g., the software components, a portion of software, a portion of an application, etc.), wherein there can be any suitable amount of software 206 such as software ₁ to software _{M}, where M is a positive integer (including respective software features).

For instance, a client can interact with the network 202 in order to access a portion of software 206 hosted by the network 202 in order to provide a “light” version of the software and/or software features. By hosting the software 206, the client can be ranked according to skill in which data access for tips, tactics, suggestions, and the like can be accessed accordingly. In another instance, the clients 204 can host the software 206 to allow client-side evaluation (e.g., a “light” smart help component 102 on client machine) of skill level in order to allow the smart help component 102 to distribute instructional data or informational tip(s) based on such determined skill level. Additionally, it is to be appreciated that the network 202 can be utilized to collect and/or distribute instructional data or informative tips from and/or to the plurality of clients 204. For instance, a user can upload an informative tip or instructional data to the network 202 for a specific software feature that corresponds to the user's skill level (discussed in more detail below).

The system 200 can further include a data store 208 that can include any suitable data related to the smart help component 102, network 202, clients 204, software 206, data requests, etc. For example, the data store 208 can include, but not limited to including, skill level data, user/client/entity data, instructional data, informative tip data, security settings, client preferences, software, a software feature, verification data (discussed below), testing data (discussed below), reward data (e.g., discussed below), translation data (discussed below), and/or any other suitable data related to the system 200.

It is to be appreciated that the data store 208 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 208 of the subject systems and methods is intended to comprise, without being limited to, these and any other suitable types of memory. In addition, it is to be appreciated that the data store 208 can be a server, a database, a hard drive, a pen drive, an external hard drive, a portable hard drive, and the like.

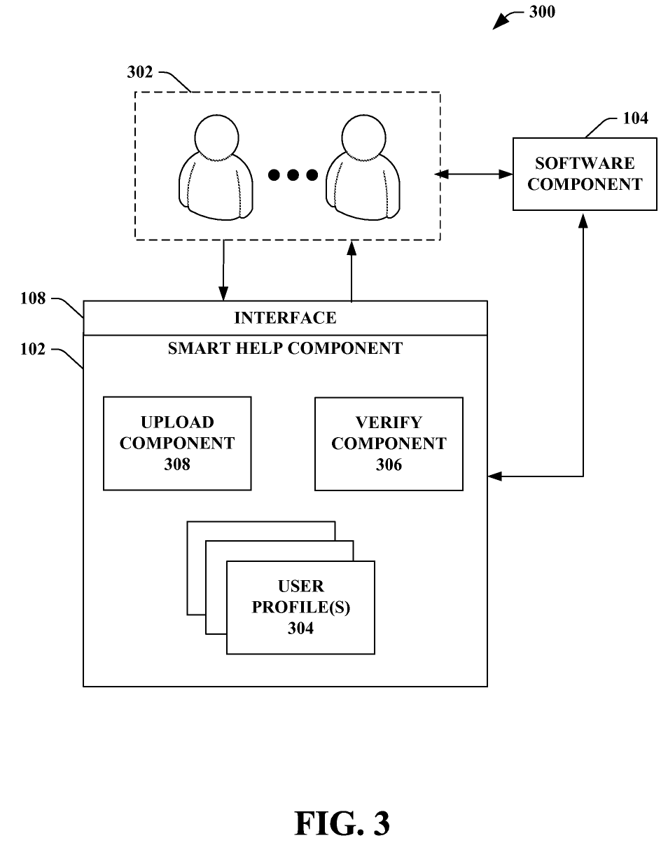

FIG. 3 illustrates a system 300 that facilitates accumulating a software suggestion for usability while providing verification of such suggestion. The system 300 can include the smart help component 102 that enables helpful data related to the software component 104 or a software feature (not shown) to be selectively distributed to a plurality of entities 302 using skill level as a factor. For example, a high level of skill related to the software component 104 can enable an entity to access high level software suggestions (e.g., modifications, tips, instructional data, tactics, shortcuts, techniques, etc.). Generally, the system 300 can increase efficient usage from the software component 104 and/or any included software features.

The smart help component 102 can utilize at least one user profile 304 that can be associated with the plurality of entities 302. For instance, a user profile 304 can be assigned to an entity with corresponding options particular to such entity such as, but not limited to, a configuration, a skill rank, a username, a password, a setting, an upload option, a download option, a data access setting, a communication preference (e.g., email address, web site, mail, hours of availability, etc.), software preferences or listings, skill definitions (e.g., rankings associated with various software and/or software features, etc.), etc. Moreover, it is to be appreciated that there can be any suitable number of user profiles 304 associated with the entities 302 and that each specific profile can include any suitable number of granular roles (e.g., personas). For instance, a user A can include a corresponding user profile with various roles based on location (e.g., home, office, work, travel, etc.), device (e.g., laptop, laptop, mobile device, portable digital assistant (PDA), etc.), network (e.g., home network, cellular network, work network, etc.), time of day, season, age, and/or any other suitable criteria an entity may want to use for role definition.

The smart help component 102 can further include a verify component 306 that implements various data verification techniques to ensure the integrity of the system 300. For instance, the verify component 306 can authenticate the plurality of entities 302, the user profiles 304, a portion of data submitted by one of the entities 302, a portion of data distributed to one of the entities 302, the software component 104, a software feature, and/or any other data related to the system 300. For example, the verify component 306 can verify a user upon connecting to the smart help component 102 and/or a related network (not shown). In another example, the verify component 306 can authenticate a user profile associated with a client, entity, or user. In general, the verify component 306 allows data (e.g., instructional data, information tip, suggestions related to software, software feature advice, etc.) distributed and/or collected to be secured from potential threats (e.g., SPAM, virus, worms, Trojan horse, file protection, corruption prevention, inaccurate data prevention, identify theft, etc.).

The system 300 can further include an upload component 308 that can aggregate informative tips or instructional data related to the software component 104 and/or the software feature associated therewith. The upload component 308 can collect any suitable data regardless of format or file type for dynamic distribution. It is to be appreciated that the data can be collected by any suitable entity such as, but not limited to, a user, a client, a company, a developer, a software component manufacturer, a third-party, a web site, a forum, an email, a device, a network, a server, a news feed, etc. For instance, the upload component 308 can receive a portion of data via the plurality of entities 302, wherein each portion of data can be verified (e.g., utilizing the verify component 306) and evaluated. Moreover, the upload component 308 can evaluate the portion of data collected in order to identify a corresponding skill level, wherein the skill level can be utilized as a rule for distribution. In other words, the upload component 308 can evaluate and recommend a skill level for received instructional data or informative tip.

For example, a portion of data received from an entity can be authenticated by the verify component 306 prior to exposing and/or distributing such data to skill level corresponding entities (e.g., allowing an entity with a high enough skill level to access the portion of data). The authentication can include, for instance, verification of the source (e.g., an entity, a client, a user, a network, etc.), authentication of a use profile 304, and/or approval of the portion of data received. The portion of data (e.g., tip, tactic, suggestion, modification, customization, shortcut, etc.) can be approved by testing, experimentation, and/or implementation. Thus, if an entity uploads a shortcut or trick related to a software feature, the entity can be verified as well as the trick or shortcut (e.g., ensuring such trick or shortcut can be performed).

In accordance with one aspect of the subject innovation, technical support for the software component 104 or the software feature can leverage the smart help component 102 to optimize assistance to users, clients, consumer, etc. For instance, a live chat, live help, or physical assistance can be employed to provide data to a user based on skill level. Technical support can answer questions leveraging the rich data collected by the smart help component 102 and/or the upload component 308 in order to provide information that is commonly asked about. Thus, the smart help component 102 can be a vehicle to distribute information to a disparate technical support employee, a user requesting assistance, etc.

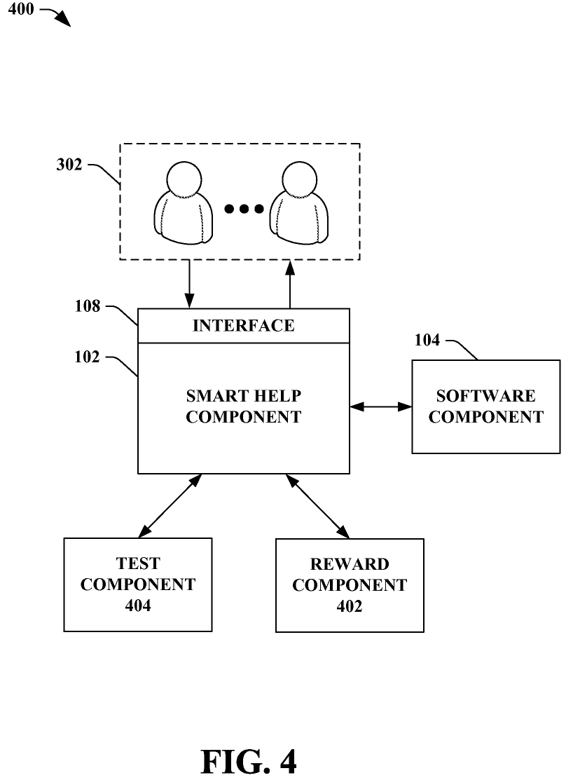

FIG. 4 illustrates a system 400 that facilitates improving consumer knowledge and skill level associated with an application utilizing a test. The system 400 can include the smart help component 102 that can provide a portion of data that assists the plurality of entities 302 in utilizing the software component 104 and/or a software feature. The smart help component 102 can employ a reward component 402 that can compensate for receipt of data related to the software component 104 and/or a software feature. The reward component 402 can allow an incentive to the plurality of entities 302 and/or any other contributor with at least one of a monetary gift, a coupon, a discount, an item (e.g., a toy, an article of clothing, a meal, a calendar, a joystick, a computer part, a speaker set, a monitor, a mouse, a head set, a keyboard, a good, etc.), a membership, a service, a security access, a data access, a credit, an offer, a portion of software, an upgrade to software, a software license, a renewal for software, an increase in a skill level ranking, an increase in a rating, an amount of data, an amount of web space, and/or any other suitable incentive (e.g., physical, virtual, and/or any combination thereof) that encourages the donation of data.

The smart help component 102 can further utilize a test component 404 that can examine skill level with a hierarchy of tests. In other words, the test component 404 can implement a test or a series of tests to identify, promote, or demote a skill level for an entity in relation to the software component 104 and/or a software feature. In general, the test component 404 can provide at least one of the following: an examination of a skill level for the entity with a test, wherein the test provides at least one of a promotion of skill level, no change in skill level, or a demotion of skill level; or a portion of data related to at least one of raising a skill level, an instruction related to raising a skill level, an instruction related to taking a test, informative material, or learning material. For instance, if you want to raise your skill level, the test component 404 can provide the “how to's” and other instructional or learning material. Once this material is received, the test component 404 can provide a test to see if you pass. For instance, a particular software feature can include a collection of tests which can identify a skill level related to the software feature and allow promotion or demotion from such identified skill level. In one example, the test component 404 can initiate a preliminary test to identify a skill level. Once an initial skill level has been determined, the test component 404 can initiate an additional test(s) which, based on success or failure, can promote, not change, or demote the skill level. In general, the test component 404 can allow a user to climb a skill level ladder with the successful completion of test(s). The test component 404 can, for instance, provide any suitable test or criteria to measure knowledge (e.g., skill level) such as, but not limited to, a series of tasks to complete, an amount of time using the software or software feature, a multiple choice test, a questionnaire, a tutorial, an amount of data contributed to the smart help component 102, a fill-in-the-blank test, a duration of membership to the smart help component 102, a test taken verbally, an evaluation of live video, an evaluation of video, etc.

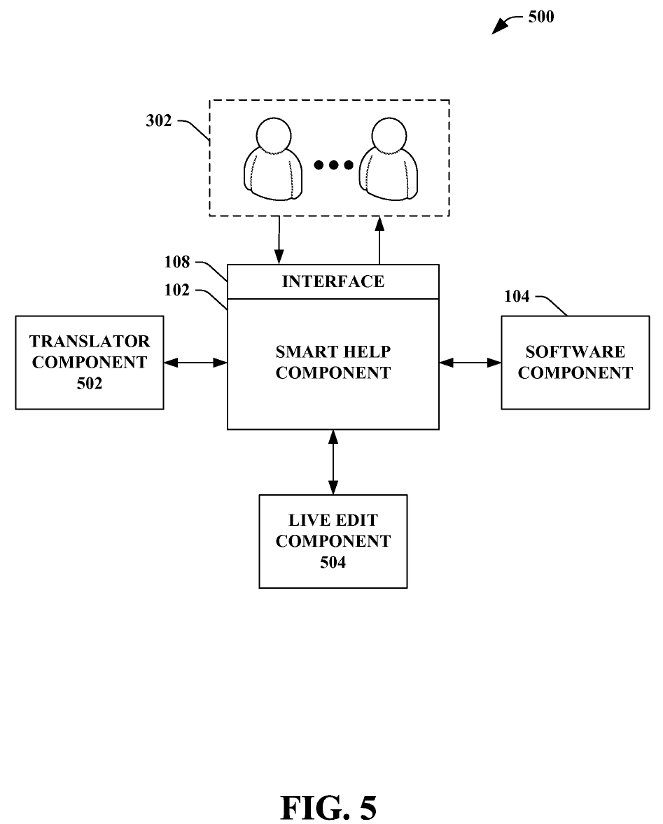

FIG. 5 illustrates a system 500 that facilities incorporating language translation and real time editing into a word processing application. The system 500 can include the smart help component 102 that can distribute informative data related to the software component 104 based on a skill level of a target (e.g., the entity that requests the informative data). In particular, the plurality of entities 302 can include a respective skill level (e.g., pre-determined, dynamically identified, tested to identify, etc.) that can allow access or restriction to particular portions of data related to software component 104 or software feature tips, tactics, customizations, modifications, suggested techniques, shortcuts, easier techniques, etc. By correlating the skill level with the information access for the software component 104 and/or a software feature, the system 500 gradually progresses an entity's understanding of such products (e.g., the software component 104, the software feature, etc.).

A translator component 502 can be utilized by the smart help component 102 to provide language tools that automatically converse and translate in multiple languages. For instance, the language tools can translate informative tips, instructional data, and the like. Moreover, such language tools can allow data requests to be received and/or communicated in numerous languages. For instance, a user in Cleveland, Ohio that speaks English can contribute a tip related to a word processing document at a level one skill level. The translator component 502 enables such tip to be translated into, for instance, Spanish, and distributed to a user with level one skill level in Santiago, Chile. Furthermore, the smart help component 102 can implement varying skill levels to entities based on a geographic area or location. For example, a group speaking language A can have a different skill level scale in comparison to a group speaking language B. It is to be appreciated that the translator component 502 can interpret any portion of data related to the system 500 into any language spoken in the world such as, but not limited to, English, Chinese, Spanish, French, Portuguese, Swahili, German, Russian, Japanese, Bengali, Hindi, Urdu, Arabic, Punjabi, and/or any other written or spoken language associated with mankind.

The smart help component 102 can further employ a live edit component 504 that enables real time collaboration in connection with the software component 104 or a software feature. In other words, the live edit component 504 enables the plurality of entities 302 to collaborate on a file or a portion of data in real time, wherein the real time collaboration increases efficiency in regards to at least one of creation, review, finalization, proofing, etc. It is to be appreciated that the real time collaborative editing can be in any suitable form or type such as audio editing, video editing, text editing, handwriting, editing with images or graphics, white boarding, and/or any other suitable editing. For instance, a meeting can be established with a live edit file in which the meeting members can annotate, append, create, review, etc. In one example, the live edit file can include a hyperlink that can track the history associated therewith (e.g., origin, editors, time, trail of file, etc.). The file or data can be any suitable data related to the software component 104 or a software feature (e.g., file, a tip, a tactic, a word processing document, a presentation, a slide show, a spreadsheet, an email, a text message, an instant message, etc.).

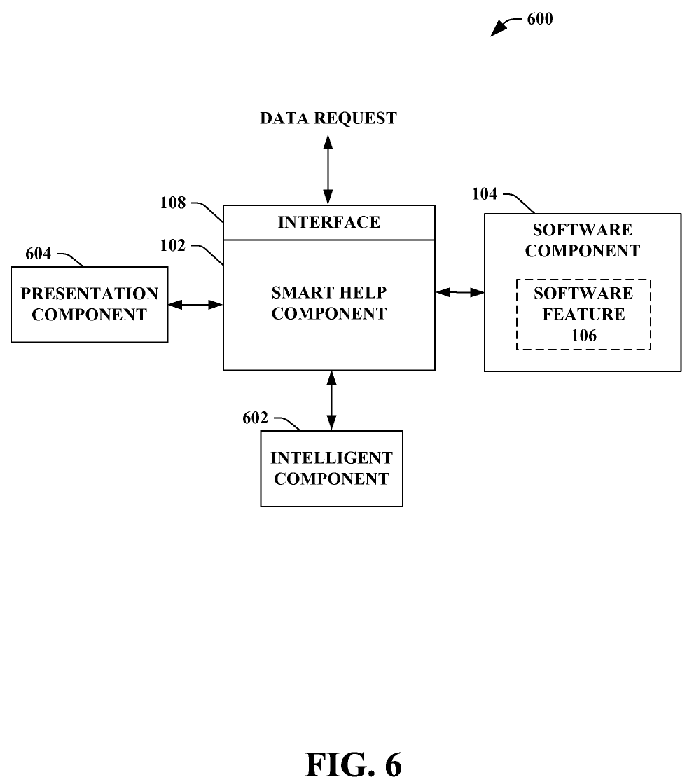

FIG. 6 illustrates a system 600 that employs intelligence to facilitate sharing an experience related to a software capability or feature. The system 600 can include the smart help component 102, the software component 104, the software feature 106, and the interface 108. It is to be appreciated that the smart help component 102, the software component 104, the software feature 106, and the interface 108 can be substantially similar to respective components, features, and interfaces described in previous figures. The system 600 further includes an intelligent component 602. The intelligent component 602 can be utilized by the smart help component 102 to facilitate supplying advice related to the software component 104 and/or the software feature 106 based on skill level or competence related thereto. For example, the intelligent component 602 can infer entity skill level, user profiles, settings, configurations, software utilized by an entity, software feature utilized by an entity, software experience, verification data, uploaded data skill level, tests related to determining skill level, tests to advance or promote a skill level, a portion of data to advance a skill level, a reward, an incentive, a desired language, a translation, an editor for a live edit collaboration, data related to a live edit collaboration, a solution, a tip, a modification, a tactic, a portion of advice, instructional data, an informative tip, a technique related to software, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The smart help component 102 can further utilize a presentation component 604 that provides various types of user interfaces to facilitate interaction between a user and any component coupled to the smart help component 102. As depicted, the presentation component 604 is a separate entity that can be utilized with the smart help component 102. However, it is to be appreciated that the presentation component 604 and/or similar view components can be incorporated into the smart help component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the smart help component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

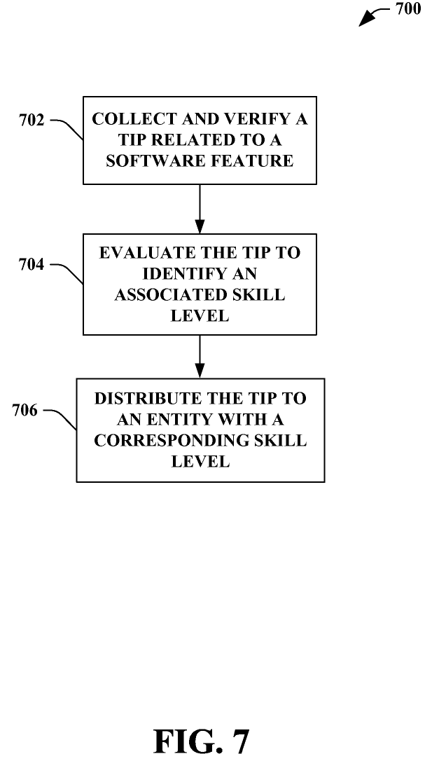

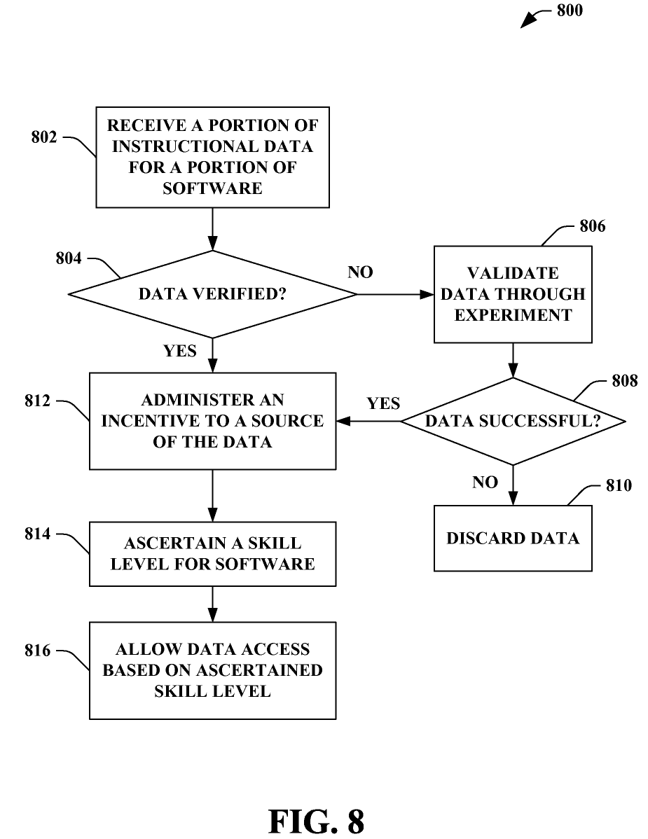

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates distributing a tip related to a software feature or capability based on skill level. At reference numeral 702, a tip related to a software feature can be collected and verified. For instance, the tip can be instructional data, informative data, a suggestion, a trick, a tactic, a tutorial, a shortcut, an experience from a client, a glitch exposure, an error avoidance, a solution to a problem, a best practice, a software or product recommendation, a modification, a customization, a recommended use, etc. Furthermore, it is to be appreciated that the tip can be in any suitable format or file type such as, but not limited to, a portion of audio, a portion of video, a portion of text, a portion of a graphic, a portion of handwriting, a slide show, a presentation, and/or any suitable combination thereof.

At reference numeral 704, the tip can be evaluated to identify an associated skill level. For example, the tip source can be evaluated to identify a skill level assuming that the skill level of the source will correspond to the skill level of a tip received. In another example, the tip can be examined utilizing various criteria to establish a difficulty for performing such tip. For example, criteria such as a number of steps, an amount of time, a task to which the tip applies, the software or software feature the tip applies toward, third-party evaluation (e.g., entity personal review, judge panel to review each tip, etc.), a level associated with a particular skill level test (e.g., skill level determined by a level of test to which the tip relates, etc.), entity ranking from community (e.g., member review, committee to review incoming tips, etc.), and/or any other suitable criteria that can measure a skill level for the tip.

At reference numeral 706, the tip can be distributed to an entity with a corresponding skill level. In other words, the tip can be supplied based on the evaluated and determined skill level for the contributed tip. By limiting entities to information based on skill level, more software features can be fully fleshed out and taught without exceeding entity comprehension. It is to be appreciated that the entity can be a user, a client, a machine, a corporation, a web site, an email group, a user group, a forum, a network, a server, a third-party, a business, etc. For example, a tip for a software feature can be received and categorized as a high skill level tip. Such high skill level tip would overwhelm a novice user, thus limitation of such tip to high skill level users enables novice users to learn software features at a comfortable pace.

FIG. 8 illustrates a method 800 for rewarding a source for the submission of a software tip and providing skill level based data access. At reference numeral 802, a portion of instructional data for a portion of software can be received. The portion of instructional data can be any suitable data that assists in relation to performing a task with software (e.g., a portion of software, an application, a portion of an application, etc.). At reference numeral 804, a determination is made whether the data has been verified. If the data has not been verified (e.g., NO), the method 800 continues to reference numeral 806. At reference numeral 806, the instructional data can be validated through experiment. For instance, the instructional data can be verified by proving a successful completion or confirmation of such data. From the validation, the method 800 continues to reference numeral 808 to determine whether or not the verification through experiment was successful. If the experiment was not successful (e.g., NO), the method 800 can continue to reference numeral 810 in which the instructional data is discarded.

If the experiment was successful (e.g., YES), the method can continue to reference numeral 812. Moreover, if the data had been verified at reference numeral 804 (e.g., YES), the method 800 can continue to reference numeral 812. At reference numeral 812, an incentive can be administered to a source of the instructional data. In other words, a contributor or originator of the instructional data (e.g., the source) can be rewarded. The incentive can be, but is not limited to being, a monetary gift, a coupon, a discount, an item (e.g., a toy, an article of clothing, a meal, a calendar, a joystick, a computer part, a speaker set, a monitor, a mouse, a head set, a keyboard, a good, etc.), a membership, a service, a security access, a data access, a credit, an offer, a portion of software, an upgrade to software, a software license, a renewal for software, an increase in a skill level ranking, an increase in a rating, an amount of data, an amount of web space, and/or any other suitable incentive (e.g., physical, virtual, and/or any combination thereof) that encourages the donation of data.

At reference numeral 814, a skill level can be ascertained for the portion of software. The skill level can be ascertained, for example, by evaluating the source of the instructional data, the verification process (e.g., third-party review), and/or various other criteria that can measure difficulty of performing or utilizing the instructional data. At reference numeral 816, data access can be allowed based on the ascertained skill level of the instructional data. Thus, data access can be limited or expanded based on a low or high skill level in order to ensure appropriate supply toward entities.

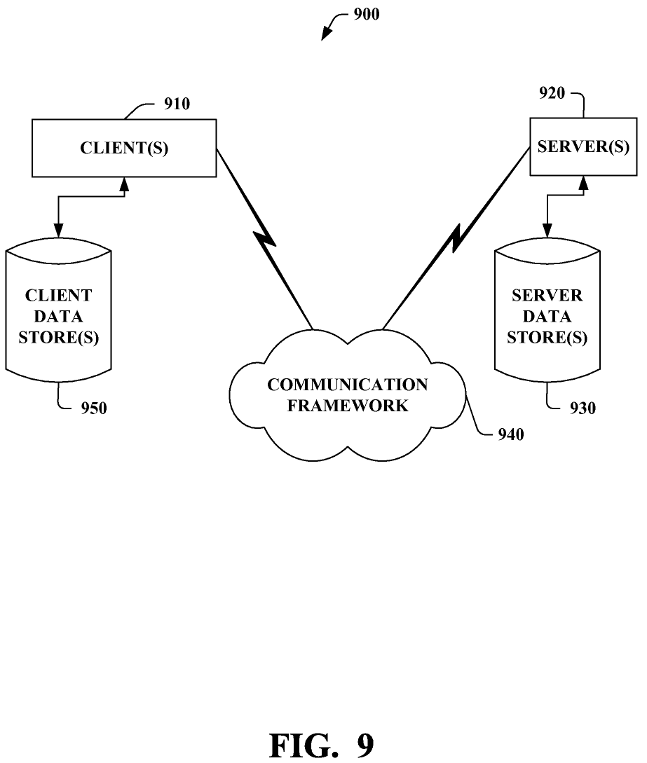

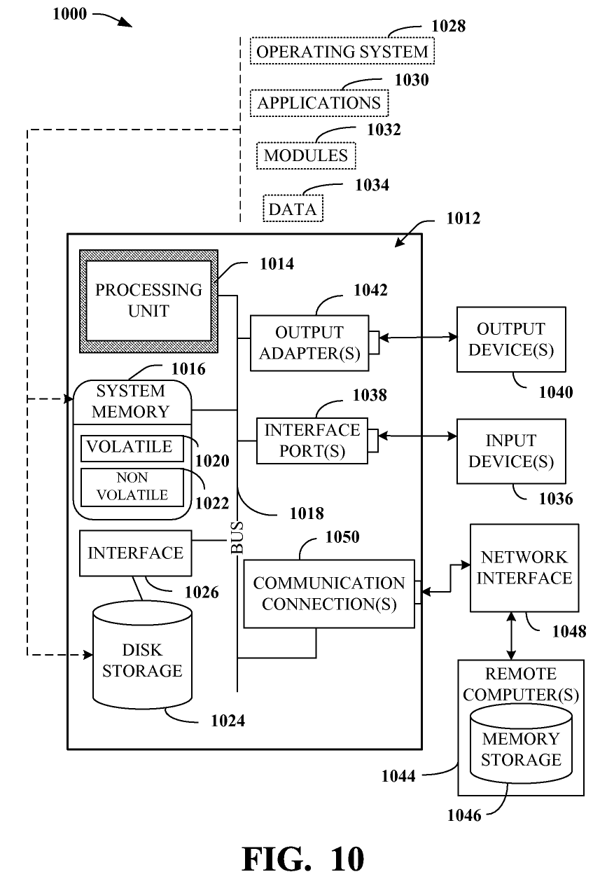

In order to provide additional context for implementing various aspects of the claimed subject matter, FIGS. 9-10 and the following discussion is intended to provide a brief, general description of a suitable computing environment in which the various aspects of the subject innovation may be implemented. For example, a smart help component that facilitates collecting and exposing software features corresponding to skill levels, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A computer implemented system that facilitates providing instructional data related to a portion of software, comprising:
a software component that includes a plurality of software features, the software component ranks and assigns a skill level to an entity utilizing at least one software feature; and
a smart help component that supplies the entity with an informative tip based on the skill level rank, the informative tip is determined by the entity's behavior within a social network and the informative tip assists in utilizing at least one software feature.

2. The system of claim 1, the informative tip is at least one of the following:
a singleton that is at least one of a portion of instructional data, a suggestion, a trick, a tactic, a tutorial, a shortcut, an experience from a client, a glitch exposure, an error avoidance, a solution to a problem, an optimal practice, a software recommendation, a product recommendation, a modification, a customization, or a recommended use; or
a synthetic tip that is generated on the fly, wherein the synthetic tip is at least one of a portion of data aggregated across two or more users, a collection of data representative of a tactic utilized by two or more users, or a portion of data dynamically correlating with a tip utilized by an entity with a similar skill level.

3. The system of claim 2, the informative tip is at least one of a portion of audio, a portion of video, a portion of text, a portion of a graphic, a portion of handwriting, a slide show, or a presentation.

4. The system of claim 1, the entity is at least one of a user, a client, a machine, a corporation, a web site, an email group, a user group, a forum, a network, a server, a third-party, or a business.

5. The system of claim 1, further comprising a verify component that authenticates at least one of the entity, the skill level, the informative tip, the software, or the software feature.

6. The system of claim 5, further comprising an upload component that gathers an informative tip from at least one entity, the informative tip is authenticated by the verify component prior to distribution by the smart help component.

7. The system of claim 1, further comprising a user profile that is linked to the entity and includes at least one option specific the entity.

8. The system of claim 7, the option relates to at least one of a configuration for upload, a configuration for download, a configuration for data access, a skill rank, a username, a password, a setting, an instructional data access setting, a communication preference, a software preference, a listing of software, or a skill definition.

9. The system of claim 1, further comprising a test component that provides at least one of the following:
an examination of a skill level for the entity with a test, wherein the test provides at least one of a promotion of skill level, no change in skill level, or a demotion of skill level; or
a portion of data related to at least one of raising a skill level, an instruction related to raising a skill level, an instruction related to taking a test, informative material, or learning material.

10. The system of claim 9, the test component employs a hierarchy of tests in which each passing of a test raises a skill level.

11. The system of claim 9, the test component initiates a preliminary test to identify a starting skill level for the entity.

12. The system of claim 9, the test component measures skill level with at least one of a test, a series of tasks to complete, an amount of time using the software, an amount of time using the software feature, a multiple choice test, a questionnaire, a tutorial, an amount of data contributed to the smart help component, a fill-in-the-blank test, a duration of membership to the smart help component, a test taken verbally, or an evaluation of video.

13. The system of claim 1, further comprising a translator component that automatically enables the informative tip to be conversed and translated into one or more languages.

14. The system of claim 13, the information tip is received in a first language and the translator component translates the informative tip into a second language.

15. The system of claim 1, further comprising a live edit component that allows two or more entities to dynamically collaborate at least one of the following in real time: the informative tip; a file associated with the software component; or a file associated with the software feature.

16. The system of claim 15, the collaboration is associated with at least one of informative tip creation, file creation, informative tip review, file review, informative tip finalization, file finalization, informative tip proofing, or a file proofing.

17. A computer-implemented method that facilitates exposing an aspect related to a portion of software, comprising:
collecting a tip related to a software feature;
verifying the tip;
evaluating the tip to identify an associated skill level; and
distributing the tip to an entity, the entity has a corresponding skill level to the tip.

18. The method of claim 17, the tip is at least one of a portion of instructional data, a suggestion, a trick, a tactic, a tutorial, a shortcut, an experience from a client, a glitch exposure, an error avoidance, a solution to a problem, an optimal practice, a software recommendation, a product recommendation, a modification, a customization, or a recommended use.

19. The method of claim 17, further comprising:
evaluating the entity to identify a skill level;
validating the tip through an experiment;
administering an incentive to a source of the tip;
translating the tip from a source language to a second language; and
allowing two or more entities to collaborate on the tip in real time.

20. A computer-implemented system that facilitates providing instructional data related to a portion of software, comprising:
means for including a plurality of software features into a software component;
means for employing a skill level ranking to an entity utilizing at least one software feature; and
means for supplying the entity with an informative tip based on the skill level ranking to assist at in utilizing the at least one software feature.
